(19) United States
(12) Patent Application Publication
(10) Pub. No.: US 2020/0276781 A1
(43) Pub. Date: Sep. 3, 2020

(54) COMPACTING SYSTEM AND METHOD

(71) Applicant: Richard Arnold, South Bend, IN (US)

(72) Inventor: Richard Arnold, South Bend, IN (US)

(21) Appl. No.: 16/799,216

(22) Filed: Feb. 24, 2020

Related U.S. Application Data
(60) Provisional application No. 62/811,671, filed on Feb. 28, 2019.

(51) Int. Cl. B30B 9/30

(52) U.S. Cl. CPC B30B 9/3007; B30B 9/3042

(57) ABSTRACT

A compacting system includes a container, a ram extendable into the container to compact waste, and a gate that is selectively deployable to close off the opening in the container to prevent the fallback of waste into the loading area. The system also includes at least one sensor for providing information as to an actual level of waste within the container.

### CROSS-REFERENCE TO RELATED APPLICATIONS

This application claims the benefit of U.S. Provisional Application Ser. No. 62/811,671, filed on Feb. 28, 2019, which is hereby incorporated by reference herein in its entirety.

### FIELD OF THE INVENTION

The present invention relates generally to systems, methods and apparatuses for compacting and handling waste material and the like and, more particularly, to improved means for receiving, compacting and facilitating the conveyance and disposal of waste material.

### BACKGROUND OF THE INVENTION

Waste compactors are used to compact waste and refuse materials to reduce the size and volume of the materials. It is desirable to compact waste and refuse materials for a number of reasons. For example, it is desirable to compact waste and refuse materials to into an economically manageable size to reduce the space that is taken up by the materials in waste containers, dumps, landfills, etc. It is also desirable to compact waste and refuse materials to reduce the frequency of which a waste container must be emptied, in order to reduce the costs associated with the emptying of the waste container.

Waste compactors are available in various sizes, from relatively small units which are utilized in the home, to large scale industrial systems. Regardless of size, however, the typical compactor utilizes an actuatable ram for compressing the waste into a reduced volume. Generally, a hydraulically operated cylinder and piston assembly is connected to the ram for reciprocally displacing the ram between a waste-receiving and a waste-compressed position. In larger units, the compressed waste holding container is separable from the ram unit in order to permit changing of the containers as they are filled.

Frequently, the user of the compactor utilizes a waste hauler for the purpose of changing the filled container. Naturally, the cost of changing the containers will be related to the number of containers which are changed. Consequently, it is economically advantageous for the user of the compactor to utilize the services of the hauler only at such times as when the compactor is full. Conventional compactors, including the containers, fail to provide any indication of when the container is approaching fullness. Therefore, the user must estimate the amount of waste which is contained therein if he is to minimize his hauling costs.

In addition to the above, conventional compactors often suffer from waste fallback or spring-back, whereby when trash is loaded into the hopper or loading area, compacted, and the ram is retracted, some portion of the waste will fall back or spill into the loading area. Such phenomenon, and the presence of waste in the loading area after compacting, reduces the amount of new waste that can be loaded into the loading area, and may give the false indication that the waste holding container is full. Accordingly, waste fallback may trigger premature emptying of the container.

In view of the above, there is a need for a compacting system and method that inhibits compacted waste from falling or retracting into the loading/hopper area, and provides an accurate indication of when the waste holding container is full.

### SUMMARY OF THE INVENTION

It is an object of the present invention to provide a compacting system capable of indicating when refuse and waste material has been compacted within a waste holding container to its practical capacity.

It is an object of the present invention to provide a compacting system that prevents waste from falling back into a loading area of the system.

It is an object of the present invention to provide a compacting system that automatically deploys a gate or like means to prevent waste from falling back into the loading area in response to feedback from sensors.

These and other objects are achieved by the present invention.

A compacting system includes a container, a ram extendable into the container to compact waste, and a gate that is selectively deployable to close off the opening in the container to prevent the fallback of waste into the loading area. The system also includes at least one sensor for providing information as to an actual level of waste within the container.

In an embodiment, a compacting system includes a container having an open end, the container having at least one sensor for detecting a level of waste within the container, and a compactor apparatus aligned with the open end of the container, the compactor apparatus having a loading area for the loading of waste, and a ram, the ram being movable between a retracted position in which the ram is positioned rearward of the loading area, and a compacting position in which the ram extends through the open end of the container and into the container to move the waste from the loading area into the container.

In another embodiment, a method for compacting waste includes the steps of providing a container having an open end and at least one pressure sensor configured to detect a level of waste within the container, providing a compacting apparatus having a loading area for receiving waste, and compacting ram movable between a retracted position and a deployed position, actuating the compacting ram to move waste from the loading area into the container, and receiving feedback from the at least one pressure sensor regarding the level of waste within the container after the compacting ram moves the waste into the container.

In yet another embodiment, a compacting system includes a container having an open end, the container having at least one pressure sensor configured to detect a level of waste within the container, a compactor apparatus aligned with the open end of the container, the compactor apparatus having a hopper, a loading area in communication with the hopper and being configured to receive a quantity of waste loaded into the hopper, and a compacting ram, the ram being movable between a retracted position in which the compacting ram is positioned rearward of the loading area, and a compacting position in which the compacting ram extends through the open end of the container and into the container to move the quantity of waste from the loading area into the container, and a controller configured to receive information from the at least one sensor regarding a level of waste within the container.

### BRIEF DESCRIPTION OF THE DRAWINGS

The present invention will be better understood from reading the following description of non-limiting embodiments, with reference to the attached drawings, wherein below:

FIG. 1 is a side elevational view of a compacting system according to an embodiment of the present invention.

FIG. 2 is a top plan view of the compacting system of FIG. 1.

FIG. 3 is a simplified perspective view of the compacting system of FIG. 1.

FIG. 4 is a detailed perspective view of a portion of the compacting system of FIG. 1.

FIG. 5 is a detailed perspective view of a gate of the compacting system of FIG. 1.

FIG. 6 is a schematic illustration of the compacting system of FIG. 1, illustrating the gate and ram in a retracted position.

FIG. 7 is a schematic illustration of the compacting system of FIG. 1, illustrating the gate in a lowered/closed position.

### DETAILED DESCRIPTION OF THE PREFERRED EMBODIMENT

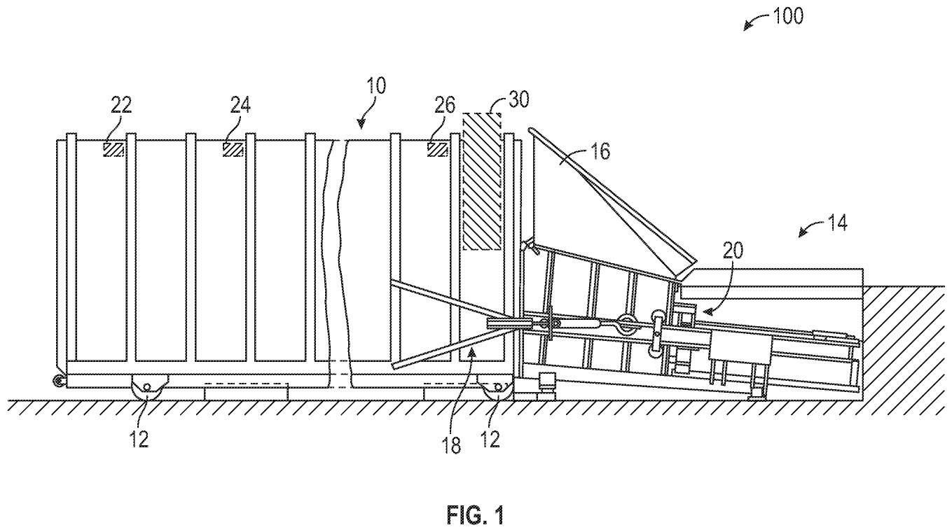

Referring to FIG. 1, there is shown a compactor container 10 supported on a rail, casters or wheels 12 and positioned for loading by-a stationary refuse compactor 14 having a charging hopper 16. The container 10 may be of conventional construction and generally is designed for use with a vehicle for transporting compacted material to a dumping area. The container may include a tailgate (not shown) which is swung open when the contained refuse is to be discharged. Such tailgate includes an opening which is aligned with the compactor 14. The container 10 and the compactor 14 are secured together by means of chains, turnbuckles or latches, such as the turnbuckle 18. Together, the container 10 and the compactor 14 form a compacting system 100.

Those skilled in this art will understand that refuse and/or waste is deposited into the charging chamber or loading area 32 of the compactor through the hopper 16, which charging chamber includes a hydraulically driven ram 20. When the charging chamber 32 is substantially filled, the operator actuates a control switch, causing the ram 20 to extend to transfer the refuse from the charging area below the hopper 16 and into the container 10 and then returns to its normal position. After a number of operating cycles, the bulk material in the container will begin to compact under the force of the ram 20. The loading of the charging chamber 32 of the compactor 14 and the compaction of the material in the container 10 is continued until the refuse in the container 10 has been fully compacted, after which the container 10 is disengaged from the compactor 14 and carted away.

To ensure that a full compacted load is carted away, one or more pressure sensors 22, 24, 26 may be positioned inside the container 10. For example, as illustrated in FIG. 1, the sensors 22, 24, 26 may be positioned adjacent to, and secured to, the roof of the container. While FIG. 1 illustrates three pressure sensors positioned at various longitudinal or axial locations within the container 10, more or fewer than three pressure sensors may be utilized without departing from the broader aspects of the invention. Moreover, while FIG. 1 illustrates the use of pressure sensors, it is contemplated that other types of sensors, such as optical sensors, may also be utilized. The pressure sensors 22, 24, 26 are communicatively coupled to a controller 50 of the compactor 14, and provide feedback to the controller indicating a level of fullness of the container 10. In an embodiment, the coupling may be a wired or wireless connection. For example, in operation, when the pressure sensor 26 is triggered by the compacting of waste within the container 10, this will indicate that waste takes up the majority of the volume within the container 10, indicating to a user that it is time to schedule a pickup. Conversely, if the pressure sensor 22 or pressure sensor 24 does not sense pressure from the compacting of waste, then this indicates that there is more room in the container 10 for waste.

While the embodiment described above discloses pressure sensors within the container 10, it is contemplated that the pressure sensor may alternatively be integrated with the ram 20. In such an embodiment, an increase in pressure seen by the ram 20 and/or the sensor integrated therewith, indicates an increase in the volume of waste within the container 10. In this respect, the pressure seen by the ram 20 can be utilized to determine how much waste is in the container 10, and ultimately whether more waste can be added or if it is time for emptying.

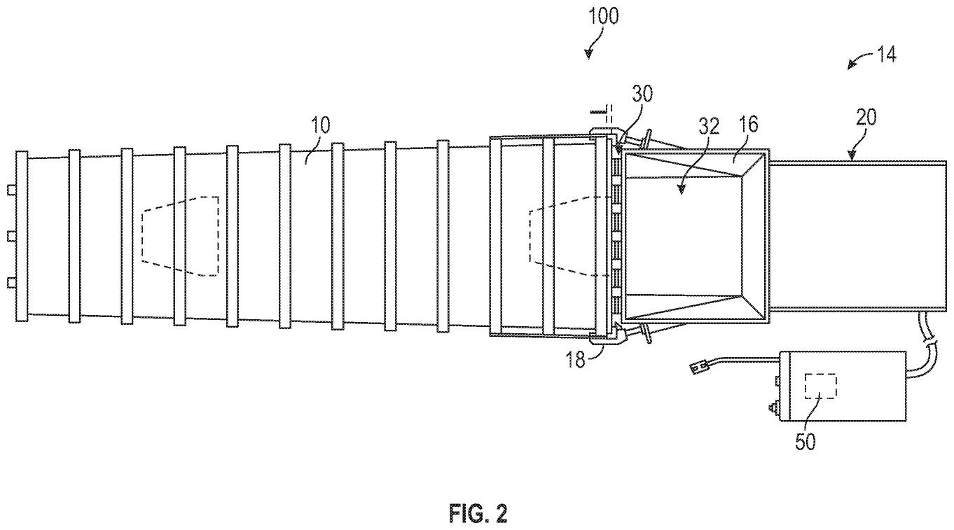

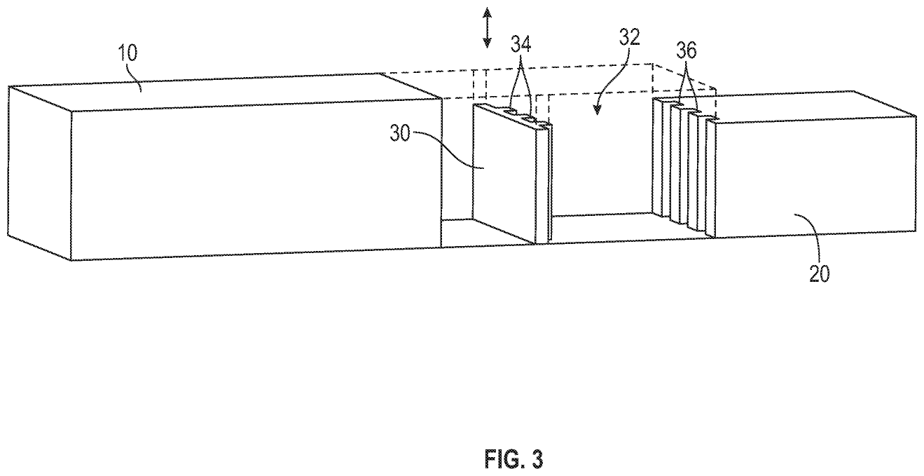

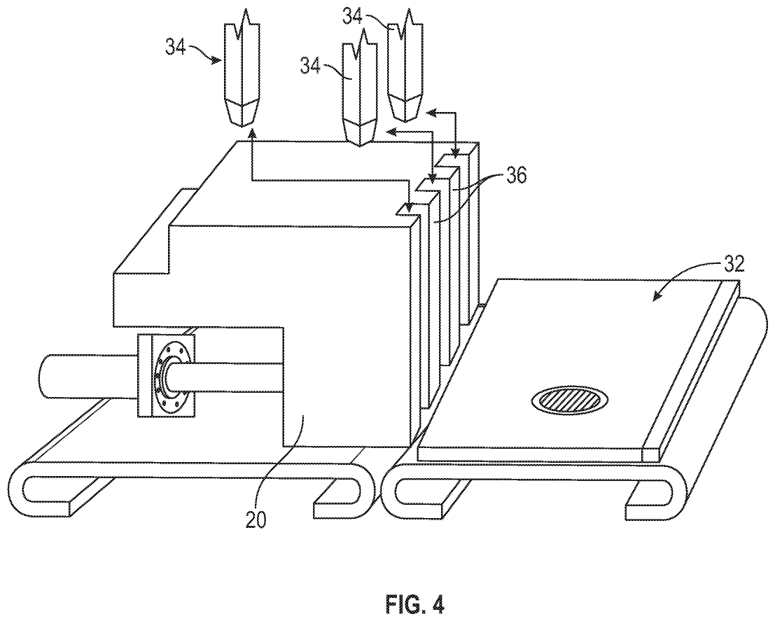

In addition to the above, and with reference to FIG. 2, in an embodiment, the system 100 may include a gate 30 that is selectively movable to close off the opening in the end of the container 10 to prevent waste from falling back into the loading area 32 beneath the hopper 16 once the ram 20 is retracted. FIG. 3 is a simplified schematic illustration showing the relative location of the container 10, ram 20, loading area 32 and gate 30. In an embodiment, the gate 30 may include a plurality of fingers or bars 34 that are configured to be received in corresponding grooves 36 in a face of the ram 20, as more clearly shown in FIG. 4.

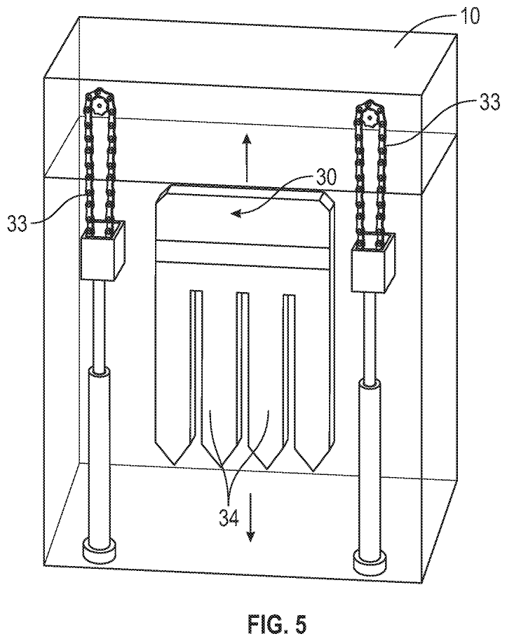

As illustrated in FIG. 5, the gate 30 is moveable upwardly and downwardly between an open position, whereby the ram 20 may enter the container 10 to compact waste, and a closed position, whereby the opening in the container 10 is closed off by the gate 30, preventing waste from falling back into the loading chamber/area 32. In an embodiment, the gate 30 may be motor driven through one or more connecting chains or linkages 33, although other driving means may be utilized without departing from the broader aspects of the invention. The gate 30 is selectively movable under control of the controller 50, and in response to feedback received from the pressure sensors and/or a position of the ram 20, as discussed hereinafter (and is thus likewise communicatively coupled therewith).

In an embodiment, the system 100 may include a display (not shown) for indicating a level of waste within the container 10, a detected by the sensors. In an embodiment, the controller 50 may be configured to generate an alert, e.g., a visual indication or audible alert as to the level of waste within the container 10, including, for example, an alert when the container 10 is at capacity or near capacity.

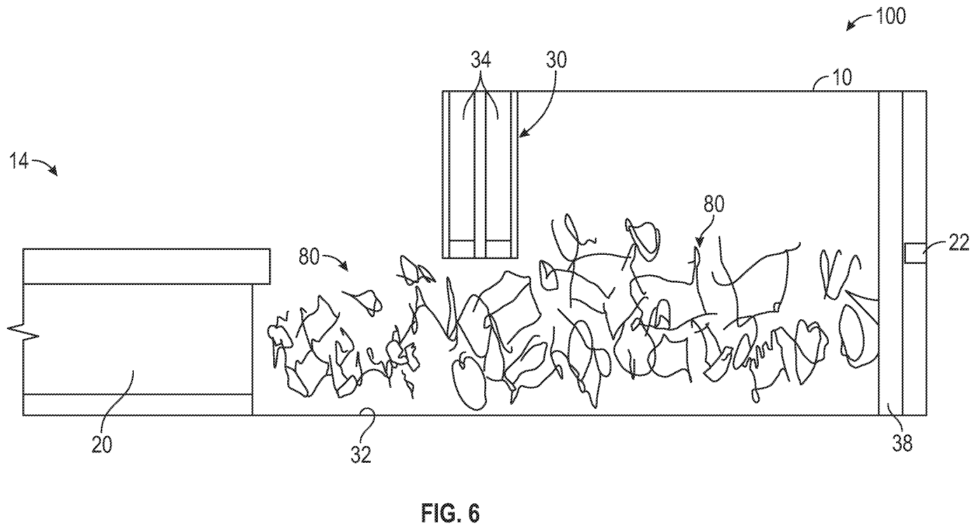

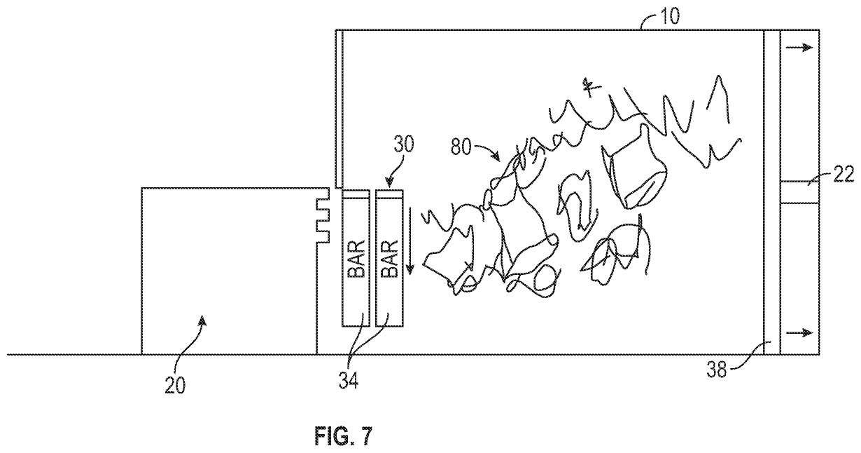

Turning now to FIGS. 6 and 7, schematic illustrations of the operation of the system are shown. With reference to FIG. 6, the ram 20 is in the retracted position and the gate 30 is up (also referred to as being in a retracted position). Waste, trash, refuse 80 or the like can then be loaded into the loading area 32 through the hopper 16. The ram 20 is then actuated to compact the waste 100 into the container 10. In doing so, the pressure sensor(s) 22, 24, 26 sense the force of the waste 100, providing feedback to the controller 50. (In FIGS. 6 and 7, the pressure sensor 22 is located on the back wall of the container 10, and is activated by a linearly movable wall 38 within the container 10 that presses against the sensor 22 under force from the ram 20.

In an embodiment, once a certain pressure level is reached (or if certain sensors detect the presence of trash), the controller 50 may automatically lower the gate 30 as the ram 20 is retracted to prevent spring-back or fallback of waste 100 into the loading area 32. FIG. 7 illustrates movement of the gate 30 to the lowered/closed position and the ram 20 retracted from the container 10. As the gate 30 is lowered, the bars or fingers 34 in the gate 30 are received in the corresponding grooves 36 of the ram 20, as discussed above. In an embodiment, each of the grooves 36 may have an associated flap cover that prevents waste from entering into the grooves 36 and obstructing the fingers 34. Importantly, the flap covers are only movable in one direction (pivoting outwardly from the face of the ram 20. The flap covers, therefore, are not moveable inwardly, preventing trash or waste from entering the grooves 36.

In particular, in operation, the ram 20 is withdrawn to a position such that the grooves 36 are directly beneath the gate 30 (and the fingers 34 thereof). The gate 30 is then lowered so that the fingers 34 of the gate 30 are received in the grooves 36 on the front face of the ram 20. At this point, the ram 20 is retracted, whereby during such movement the flap covers are opened (by simple retraction of the ram and under contact with the fingers 34 as the am pulls back). The ram 20 can then be fully retracted past the loading area 32.

Importantly, the gate 30, in its lowered position, prevents waste 100 from inside the container 10 from spilling out into the loading area 32. This maintains a clear loading area 32 for more waste 100 to be loaded, and obviates the possibility that a user will be deceived into thinking that the container 10 is full by observing waste in the loading area 32. Once additional waste is loaded into the loading area, the gate may be retracted and the ram 20 activated to compact the waste into the container 10.

Importantly, in an embodiment, the gate 30 is automatically deployed and retracted by the controller 50 in dependence upon feedback received from the sensor(s) and/or the position of the ram 20. In particular, in an embodiment, the gate 30 may be lowered or closed when a certain pressure threshold (as detected by the sensor) is reached, or simply when waste is sensed by one or more of the sensors (e.g., sensor 26). The ram 20 may then be retracted out of the container 10 and past the loading area 32. Similarly, when the ram 20 is activated to compact waste, the gate 30 may be correspondingly raised to make room for the ram 20 to enter. In other embodiments, the gate 30 may be manually activated.

Importantly, therefore, the present invention provides a compacting system 100 that prevents compacted waste from falling back into the loading area 32, which could deceive a user into thinking that the container 10 is full, as well as obstructing the loading of additional waste into the loading area 32. Furthermore, the system 100 of the present invention includes one or more sensors 22, 24, 26 that provide feedback as to the level of waste within the container 10, which can be used to trigger automatic lowering of the gate 30, as well as provide information as to the actual level of waste in the container 10 to prevent premature emptying/carry-away/disposal.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

What is claimed is:

1. A compacting system, comprising:
a container having an open end, the container having at least one sensor for detecting a level of waste within the container; and
a compactor apparatus aligned with the open end of the container, the compactor apparatus having a loading area for the loading of waste, and a ram, the ram being movable between a retracted position in which the ram is positioned rearward of the loading area, and a compacting position in which the ram extends through the open end of the container and into the container to move the waste from the loading area into the container.

2. The compacting system of claim 1, further comprising:
a controller configured to receive information from the at least one sensor regarding a level of waste within the container, and to generate an alert or indication of the level of waste within the container.

3. The compacting system of claim 2, wherein:
the at least one sensor is a plurality of sensors positioned at different axial locations within the container.

4. The compacting system of claim 2, wherein:
the plurality of sensors are pressure sensors.

5. The compacting system of claim 1, wherein:
the at least one sensor is a camera.

6. The compacting system of claim 1, further comprising:
a gate movable between a retracted position and a deployed position, wherein in the deployed position the gate is positioned across the opening in the container to close off the opening in the container.

7. The compacting system of claim 6, wherein:
the gate includes a plurality of fingers that are configured to be received in a plurality of corresponding grooves in a front face of the ram.

8. The compacting apparatus of claim 7, wherein:
the ram includes a plurality of movable flap covers extending across the grooves, the flap covers being configured to prevent the waste from entering the grooves.

9. The compacting apparatus of claim 2, wherein:
the controller is configured to control the gate to the deployed position during retraction of the ram to prevent waste in the container from entering the loading area.

10. The compacting apparatus of claim 9, wherein:
the controller is configured to control the gate to the deployed position when a pressure detected by the at least one sensor exceeds a threshold pressure.

11. The compacting apparatus of claim 9, wherein:
the at least one sensor is a pressure sensor positioned on a rear wall of the container opposite the open end; and
wherein the container includes an axially moveable wall intermediate the open end and the pressure sensor.

12. A method for compacting waste, comprising the steps of:
providing a container having an open end and at least one pressure sensor configured to detect a level of waste within the container;
providing a compacting apparatus having a loading area for receiving waste, and compacting ram movable between a retracted position and a deployed position;
actuating the compacting ram to move waste from the loading area into the container; and
receiving feedback from the at least one pressure sensor regarding the level of waste within the container after the compacting ram moves the waste into the container.

13. The method according to claim 12, further comprising the step of:
in response to the feedback from the at least one pressure sensor, generating an indication of the level of waste within the container.

14. The method according to claim 12, further comprising the step of:
retracting the compacting ram to a position where grooves in a face of the compacting ram are directly beneath bars of a gate; and
deploying the gate so that the bars of the gate are received within the grooves in the face of the compacting ram.

15. The method according to claim 14, further comprising the step of:
retracting the compacting ram to the deployed position whereby the compacting ram is positioned rearward of the loading area;
wherein when the gate is deployed the open end of the container, the gate inhibits waste within the container from spilling back into the loading area.

16. The method according to claim 15, further comprising the step of:
loading additional waste into the loading area;
actuating the compacting ram to urge the additional waste into the container; and
before the compacting ram enters the container, retracting the gate.

17. The method according to claim 14, wherein:
the compacting ram includes a plurality of movable flap covers extending across the grooves, the flap covers being configured to prevent the waste from entering the grooves.

18. A compacting system, comprising:
a container having an open end, the container having at least one pressure sensor configured to detect a level of waste within the container;
a compactor apparatus aligned with the open end of the container, the compactor apparatus having a hopper, a loading area in communication with the hopper and being configured to receive a quantity of waste loaded into the hopper, and a compacting ram, the ram being movable between a retracted position in which the compacting ram is positioned rearward of the loading area, and a compacting position in which the compacting ram extends through the open end of the container and into the container to move the quantity of waste from the loading area into the container; and
a controller configured to receive information from the at least one sensor regarding a level of waste within the container.

19. The compacting system of claim 18, further comprising:
a gate movable between a retracted position and a deployed position, wherein in the deployed position the gate is positioned across the opening in the container to close off the opening in the container.

20. The compacting system of claim 19, wherein:
the gate includes a plurality of fingers that are configured to be received in a plurality of corresponding grooves in a front face of the compacting ram.
